(19) United States
(12) Patent Application Publication
(10) Pub. No.: US 2026/0016042 A1
(43) Pub. Date: Jan. 15, 2026

(54) Screw Anchor

(71) Applicant: Illinois Tool Works Inc., Glenview, IL (US)

(72) Inventor: Philippe Rodrigues, Vaureal (FR)

(21) Appl. No.: 19/263,762

(22) Filed: Jul. 9, 2025

(30) Foreign Application Priority Data
Jul. 9, 2024 (FR) 2407478
Jul. 1, 2025 (FR) 2507413

(51) Int. Cl. F16B 37/04

(52) U.S. Cl. CPC F16B 37/042

(57) ABSTRACT

A screw anchor that includes a main body with a hole running along its central axis and a head at one end. The anchor is designed to rotate around this axis, allowing it to move from an insertion position—where it can be inserted into a non-circular hole in a metal sheet—to a locked position, where the sheet is securely held between the head of the anchor and a stop feature extending from the body.

### RELATED APPLICATIONS

The present application claims the benefit of French Patent Application Nos. 2407478, filed Jul. 9, 2024, and U.S. Pat. No. 2,507,413, filed Jul. 1, 2025, each titled “Screw Receiving Dowel,” the contents of which are hereby incorporated by reference.

### TECHNICAL FIELD

This disclosure generally relates to a screw anchor. More specifically, but not exclusively, this disclosure relates to such an anchor that is non-circular, for example rectangular or oblong, designed to be inserted into a hole in a piece of metal sheeting, for example in a vehicle or on a vehicle chassis.

### BACKGROUND

Screw anchors typically include a main body with a central hole extending along its length, a head positioned at one end of the body, and a spring clip located at a distance from the head. The spring clip is designed to engage within the central hole of the body and serves to provide a locking or retention function when the anchor is inserted into a corresponding hole in a receiving structure, such as a metal panel. Upon insertion and rotation of the anchor, the spring clip expands or shifts into a locking position, helping to secure the anchor in place and prevent unintentional withdrawal. This configuration allows the anchor to engage securely with a workpiece, especially in applications where vibration resistance or ease of installation is important.

### SUMMARY

The present disclosure relates generally to a screw anchor, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates a screw anchor according to one embodiment of the disclosure.

FIG. 2 illustrates the anchor in FIG. 1 from the opposite side.

FIG. 3 illustrates a screw anchor according to another embodiment.

FIG. 4 illustrates the anchor in FIGS. 1 and 2, or in FIG. 3, when inserted into a non-round hole.

FIG. 5 illustrates a view similar to FIG. 4, showing the anchor after its insertion.

### DETAILED DESCRIPTION OF THE DISCLOSURE

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

This disclosure aims to provide a simpler screw anchor, in particular such an anchor that can be more easily adapted to variations in hole dimensions.

The disclosure relates to a screw anchor, the anchor being rotatable from an insertion position, in which it can be inserted into a non-circular hole in a piece of metal sheeting, up to a locked position, in which it is engaged in the sheeting.

The anchor can comprise a body. The body can form a hole. The hole can extend along an axis. The anchor can comprise a head, which can be at one end of the body. The anchor can be rotatable around the axis, for example between the insertion position and the locked position.

In the insertion position, the body can be inserted into a non-circular hole in a piece of metal sheeting. In the locked position, the sheeting can be caught between the head and a stop protruding from the body.

The disclosure also relates to a screw anchor comprising a body forming a hole extending along an axis and a head at one end of the body, the anchor being rotatable around the axis from an insertion position, in which the body can be inserted into a non-circular hole in a piece of metal sheeting, up to a locked position in which the sheeting is caught between the head and a stop protruding from the body.

The anchor can be set to a locked position.

The disclosure also relates to a screw anchor comprising a body forming a hole extending along an axis and a head at one end of the body, the anchor being rotatable around the axis from an insertion position, in which the body can be inserted into a non-circular hole in a piece of metal sheeting and set to a locked position in which the sheeting is caught between the head and a stop protruding from the body.

The hole through the body can be non-circular. The stop can protrude from the main side of the body.

The disclosure also relates to a screw anchor comprising a body forming a non-circular hole extending along an axis and a head at one end of the body, in which the anchor body is configured to be inserted into a hole in a sheeting until the sheeting is caught between the head and a stop protruding from a main side of the body.

The non-circular hole through the body can be rectangular or oblong. The body can have a shape similar to that of the non-circular hole. The body can be non-circular, for example rectangular or oblong. The anchor can have a shape similar to that of the non-circular hole. The anchor can be non-circular, for example rectangular or oblong.

The body and the anchor can have a major dimension and a minor dimension, which can extend along the major and minor dimensions of the non-circular hole. The main side can extend along the major dimension.

The anchor can comprise a cam. The cam can comprise a stop, for example at one of its ends. The cam can comprise a ramp. The ramp can be configured to engage the non-circular hole, for example when the anchor is inserted. The ramp can be configured to twist the anchor, for example when it is inserted into the non-circular hole, until the sheeting is aligned with a gap between the head and the stop.

More specifically, the anchor can comprise a cam with the stop at one of its ends and a ramp configured to engage the non-circular hole and twist the anchor when it is inserted into the non-circular hole until the sheeting is aligned with a gap between the head and the stop.

The cam can be part of a pair of cams. The cams can be located on opposite sides of the anchor. Each cam can comprise a respective stop, which can be at one of its ends. Each cam can comprise a respective ramp. Each ramp can be configured to engage the non-circular hole when the anchor is inserted into the non-circular hole. Each ramp can be configured to twist the anchor when it is inserted into the non-circular hole, for example, until the sheeting is aligned with a gap between the head and the stops.

More specifically, the cam can be part of a pair of cams located on opposite sides of the anchor, each cam comprising a respective stop at one of its ends and a respective ramp configured to engage in the non-circular hole and twist the anchor when it is inserted into the non-circular hole until the sheeting is aligned with a gap between the head and the stops.

The body or the anchor can comprise a cross-section. The cross section can have a pair of long sides. The cross section can have a pair of short ends. Each cam can protrude from a respective long side. Each cam can protrude at a location offset toward one of the respective short ends.

More specifically, the body can comprise a cross-section having a pair of long sides and a pair of short ends, each cam protruding from a respective long side at a location offset toward one of the respective short ends.

The body or the anchor can have a non-circular cross-section, for example a rectangular or oblong cross-section. The non-circular hole into which the anchor is to be inserted can comprise a rectangular or oblong hole.

The anchor can comprise a setting means. The setting means can be configured to twist the anchor to the locked position, for example when the sheeting is aligned with the gap between the head and the stop.

More specifically, the anchor can comprise a setting means configured to twist the anchor to the locked position when the sheeting is aligned with the gap between the head and the stop.

The setting means can comprise a pair of fins. Each fin can protrude from one of the short ends of the body or anchor.

More specifically, the setting means can comprise a pair of fins each protruding from one of the short ends of the body.

Each fin can extend into the gap between the head and the cam stops, for example so as to twist the anchor to the locked position when the sheeting is aligned with the gap between the head and the cam stops.

More specifically, each fin can extend into the gap between the head and the cam stops so as to twist the anchor to the locked position when the sheeting is aligned with the gap between the head and the cam stops.

Each fin can comprise another stop. The sheeting can be caught between the head and the other stops on the fins, for example when the anchor is in the locked position.

More specifically, each fin can comprise another stop and the sheeting is caught between the head and the other stops on the fins when the anchor is in the locked position.

For the avoidance of doubt, all the features described herein also apply to any aspect of the disclosure.

The metal sheeting can comprise a composite structure. The metal sheeting can form part of a tailgate. The metal sheeting can be made of a composite plastic material.

The anchor can comprise a screw-in wire guide.

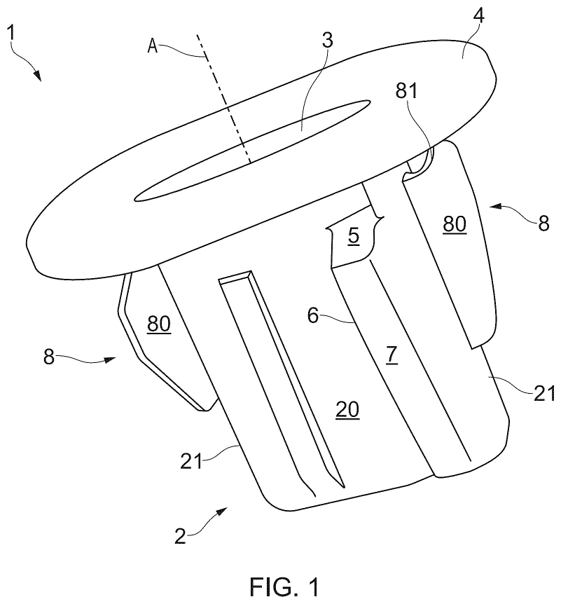

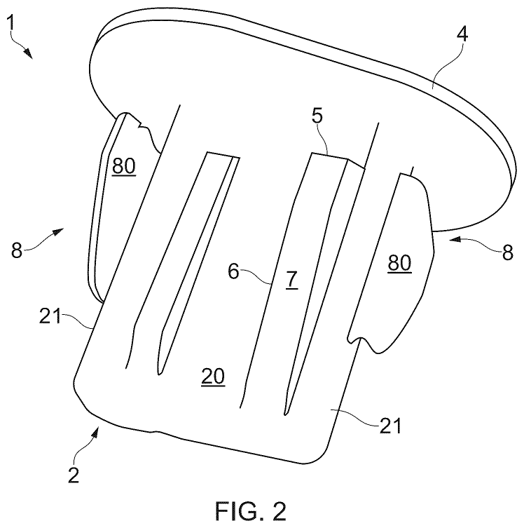

Referring now to FIGS. 1 and 2, a screw anchor 1 according to one embodiment of the disclosure can be seen. The anchor 1 comprises a body 2 forming a hole 3 extending along an axis A, a head 4 at one end of the body 2 and a pair of stops 5 protruding from the body 2. The body 2 comprises a cross-section having a pair of long sides 20 and a pair of short ends 21.

The anchor 1 also comprises a pair of cams 6 located on opposite sides of the anchor 1. More specifically, each cam 6 protrudes from a respective long side 20 at a location offset toward one of the respective short ends 21. Each cam 6 comprises a stop 5 at one end and a respective ramp 7 along its length.

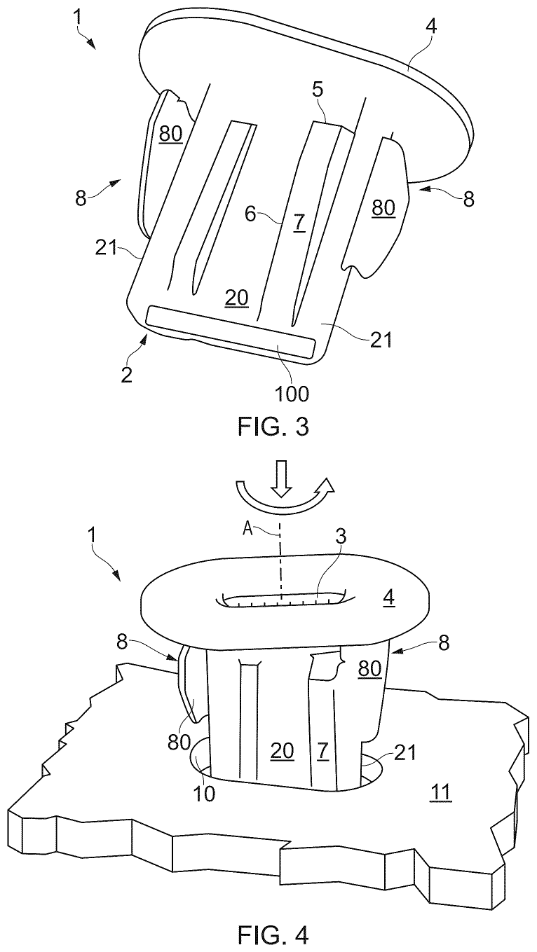

FIG. 3 illustrates a second embodiment of the screw anchor 1.

This second embodiment differs from the first embodiment only in that an axial opening 100 runs through the body 2 at an end of the body 2 opposite the head 4.

The axial opening 100 enables a screw to go through the body 2. In this way, a screw longer than the channel formed by the body 2 can go through the body 2 without damaging it, and above all such that no screw tip protrudes beyond the head 4 of the anchor 1.

This means that the screw head is at least flush with the head 4 or inserted within it. This keeps the screw head from protruding beyond the head 4, thus ensuring that the screw tip is prevented from making contact with any nearby electrical wiring.

The screw anchor 1 in the second embodiment also ensures that a screw tip does not cause any damage or premature wear to any components around the anchor.

The first embodiment can be combined with an opening that has a length that is directly adapted to the channel formed by the body 2, so as to account for the length of the screw and prevent this screw from protruding beyond the body 2, while the second embodiment offers a solution adapted to a wider variety of screw lengths.

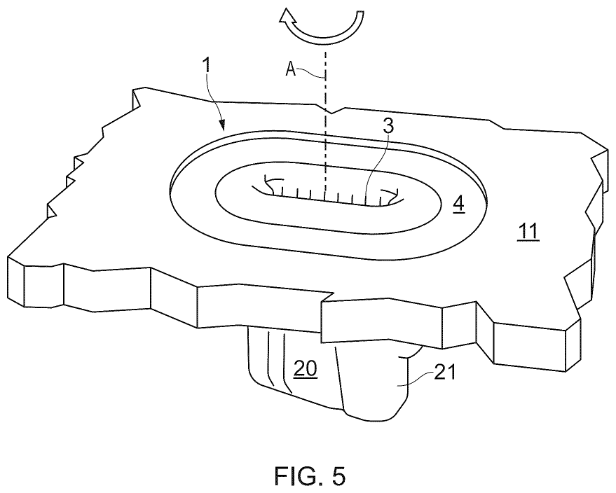

The anchor 1 is rotatable around the axis A, from an insertion position to a locked position. In the insertion position (see FIG. 4), the body 2 can be inserted into a non-circular hole 10 in a piece of metal sheeting 11. In the locked position (see FIG. 5), the sheeting 11 is caught or trapped between the head 4 and the stops 5 that protrude from the body 2.

The ramps 7 are configured to engage in the non-circular hole 10 and twist the anchor 1 when it is inserted into the non-circular hole 10, until the sheeting 11 is aligned with a gap between the head 4 and the stops 5.

The anchor 1 also comprises a setting means 8 configured to twist the anchor 1 to the locked position when the sheeting 11 is aligned with the gap between the head 4 and the stop 5. More specifically, the setting means 8 comprises a pair of fins 80 each protruding from one of the short ends 21 of the body 2.

Each fin 80 extends into the gap between the head 4 and the stops 5 on the cams 6. Each fin 80 extends along a direction parallel to the axis A and protrudes from one of the short ends 21 of the body 2 at an angle so as to engage in the non-circular hole 10 when the anchor 1 is inserted into the non-circular hole 10 and to cause the anchor 1 to twist.

As a result, the fins 80 twist the anchor 1 to the locked position when the sheeting 11 aligns with the gap between the head 4 and the stops 5 of the cams 6. Each fin 80 also comprises another stop 81 between the stops 5 of the cams 6, such that the sheeting 11 is caught between the head 4 and the other stops 81 of the fins 80 when the anchor 1 is in the locked position.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMBERS

1 Screw Anchor
2 Body
20 Long Side Of The Body
21 Short End Of The Body
3 Hole
4 Head
5 Stop
6 Cam
7 Ramp
8 Setting Means
80 Fins
81 Other Stop
10 Non-Circular Hole
11 Metal Sheeting
A Axis

What is claimed is:

1. A screw anchor (1) comprising:
a body (2) forming a hole (3) extending along an axis (A) and a head (4) at one end of the body (2),
wherein the screw anchor (1) being rotatable around the axis (A) from an insertion position, and
wherein the body (2) can be inserted into a non-circular hole (10) in a piece of metal sheeting (11) and set to a locked position in which the sheeting (11) is caught between the head (4) and a stop (5) protruding from the body (2).

2. The screw anchor (1) according to claim 1, comprising a cam (6) with the stop (5) at one of its ends and a ramp (7) configured to engage the non-circular hole (10) and twist the anchor (1) when it is inserted into the non-circular hole (10) until the sheeting (11) is aligned with a gap between the head (4) and the stop (5).

3. The screw anchor (1) according to claim 2, wherein the cam (6) is part of a pair of cams (6) located on opposite sides of the anchor (1), each cam (6) comprising a respective stop (5) at one end and a respective ramp (7) configured to engage the non-circular hole (10) and twist the anchor (1) when it is inserted into the non-circular hole (10) until the sheeting (11) is aligned with a gap between the head (4) and the stops (5).

4. The screw anchor (1) according to claim 3, wherein the body (2) comprises a cross section having a pair of long sides (20) and a pair of short ends (21), each cam (6) protruding from a respective long side (20) at a position offset toward one of the respective short ends (21).

5. The screw anchor (1) according to claim 4, comprising a setting device (8) configured to twist the anchor (1) to the locked position when the sheeting (11) is aligned with the gap between the head (4) and the stop (5).

6. The screw anchor (1) according to claim 5, wherein the setting device (8) comprises a pair of fins (80) each protruding from one of the short ends (21) of the body (2).

7. The screw anchor (1) according to claim 6, wherein each fin (80) extends into the gap between the head (4) and the stops (5) of the cams (6) so as to twist the anchor (1) to the locked position when the sheeting (11) is aligned with the gap between the head (4) and the stops (5) of the cams (6).

8. The screw anchor (1) according to claim 7, wherein each fin (80) comprises another stop (81) and the sheeting (11) is caught between the head (4) and the other stops (81) of the fins (80) when the anchor (1) is in the locked position.

9. The screw anchor (1) according to claim 1, further comprising an axial opening (100) running through the body (2) at an end of the body (2) opposite the head (4).

10. The screw anchor (1) according to claim 1, having a non-circular cross-section.

11. The screw anchor (1) according to claim 1, having a rectangular cross-section.

12. The screw anchor (1) according to claim 1, having an oblong cross-section.
